(19) United States
(12) Patent Application Publication
(10) Pub. No.: US 2022/0355785 A1
(43) Pub. Date: Nov. 10, 2022

(54) Control Unit and Method for Operating an Electric Machine of a Hybrid Drive

(71) Applicant: Bayerische Motoren Werke Aktiengesellschaft, Muenchen (DE)

(72) Inventor: Salomon AHREN, Muenchen (DE)

(21) Appl. No.: 17/627,192

(22) PCT Filed: Aug. 4, 2020
(86) PCT No.: PCT/EP2020/071895

§ 371 Date: Jan. 14, 2022

(30) Foreign Application Priority Data
Sep. 17, 2019 (DE) 10 2019 124 922.8

(51) Int. Cl. B60W 20/13; B60W 10/06; B60W 10/08; F02N 11/08

(52) U.S. Cl. CPC B60W 20/13; B60W 10/06; B60W 10/08; F02N 11/0859; F02N 11/0862; B60K 6/48

(57) ABSTRACT

A control unit for a hybrid drive of a vehicle is provided. The hybrid drive includes an internal combustion engine and an electric machine. The hybrid drive is designed in such a way that the electric machine is used for providing a drive torque of the vehicle and for starting the internal combustion engine. The control unit is configured to predict a start time, at which at least a part of the total power of the electric machine is available for a starting process of the internal combustion engine. Furthermore, the control unit is configured to start the internal combustion engine at the predicted start time by way of the electric machine.

### BACKGROUND AND SUMMARY OF THE INVENTION

The invention relates to a hybrid drive. In particular, the invention relates to the operation of the electric machine of a hybrid drive, which electric machine is used both for providing drive and for starting up an internal combustion engine of the hybrid drive.

A vehicle with hybrid drive comprises an internal combustion engine and at least one electric machine, which can be used in each case individually and/or jointly in order to impart a demanded drive torque. Furthermore, the electric machine can be used for starting the internal combustion engine when required.

The present document is concerned with the technical problem of allowing comfortable and reliable driving operation in the case of a hybrid drive in which the electric machine is used both for providing drive and for starting up the internal combustion engine.

The object is achieved by the claimed invention.

According to one aspect, a control unit for a hybrid drive is described, wherein the hybrid drive is configured to drive a motor vehicle. The hybrid drive comprises an internal combustion engine, for example a diesel engine or a gasoline engine, and an electric machine. The coupling between the internal combustion engine and the electric machine may be realized for example by way of a separating clutch. The hybrid drive may be configured such that the electric machine is used for providing the drive torque of the vehicle and for starting the internal combustion engine. In a preferred example, the hybrid drive has no dedicated starter that is used possibly only for starting the internal combustion engine, and possibly not for driving the vehicle.

The control unit may be configured to predict a (future) start-up time at which at least a proportion of the entire available total power of the electric machine is available for a starting operation of the internal combustion engine. The hybrid drive may be configured such that the total power of the electric machine can be used for driving the vehicle. In particular, it is possible here to dispense with a power reserve for starting operations of the internal combustion engine. A hybrid drive that is efficient in terms of costs, structural space and weight can thus be provided.

The start-up time may be predicted in reaction to a demand for a start-up of the internal combustion engine. The demand for the start-up of the internal combustion engine may arise from an operating strategy for the hybrid drive. In other words, the control unit may be configured to determine, on the basis of the operating strategy of the hybrid drive, that the internal combustion engine is to be started. The time at which the demand for the start-up is made may be referred to as the demand time. Then, in reaction to the demand for the start-up of the internal combustion engine, a start-up time may be predicted at which at least a proportion of the total power of the electric machine is available for the starting operation of the internal combustion engine. Here, the start-up time may chronologically follow the demand time.

The start-up time may be ascertained such that the drive of the vehicle is impaired as little as possible, or is preferably not impaired at all, by the start-up of the internal combustion engine. It is thus possible to predict a start-up time at which so little power has to be imparted by the electric machine for driving the vehicle that the drive of the vehicle is not impaired, or is impaired only to a reduced or limited extent, by the starting of the internal combustion engine.

The hybrid drive may be configured such that the electric machine is used in a chronologically exclusive manner only for providing drive or only for the starting operation of the internal combustion engine. In this case, the control unit may be configured to predict a start-up time at which the electric machine is not required for driving the vehicle.

Alternatively, the hybrid drive may be configured such that the electric machine can, out of the entire available total power, use a certain starting power for the starting operation of the internal combustion engine and the remainder of the total power for driving the vehicle. It is thus possible for a proportion of the total power to be used for a starting operation of the internal combustion engine, and a remaining proportion of the total power to be used for driving the vehicle, simultaneously. In this case, the control unit may be configured to predict a start-up time at which at most the total power minus the starting power is required for driving the vehicle.

The control unit is furthermore configured to start the internal combustion engine, possibly exclusively by operation of the electric machine, at the predicted start-up time. Comfortable and reliable operation of a hybrid drive, which comprises an electric machine that is used both for driving the vehicle and for a starting operation of the internal combustion engine, can thus be made possible.

As already discussed above, the demand for the starting of the internal combustion engine may be ascertained on the basis of an operating strategy of the hybrid drive. The operating strategy may for example be configured to specify, in a manner dependent on one or more state parameters of the vehicle and/or of the hybrid drive, whether the electric machine alone is used for driving the vehicle, whether both the electric machine and the internal combustion engine are used for driving the vehicle, and/or whether the internal combustion engine is stopped or started. Exemplary state parameters are the driving speed of the vehicle and/or the state of charge of the electrical energy store for storing the electrical energy for the operation of the electric machine.

The control unit may thus be configured to ascertain speed information relating to the traveling speed of the vehicle, and/or state of charge information relating to the state of charge of the electrical energy store for storing electrical energy for the operation of the electric machine. The speed information and/or the state of charge information may be ascertained for example at or for the demand time. It is then particularly reliably possible, in a manner dependent on the speed information and/or the state of charge information and taking into consideration the operating strategy, to determine that the internal combustion engine is to be started (at the demand time).

The control unit may be configured to ascertain, for example at the demand time, the driver demand relating to the drive torque demanded by the driver of the vehicle. The driver demand may be ascertained for example on the basis of a deflection of an accelerator pedal and/or on the basis of a deflection of a brake pedal of the vehicle. The start-up time can then be predicted in a particularly precise manner on the basis of the driver demand.

Alternatively or in addition, the control unit may be configured to ascertain dynamics information relating to the dynamics of the driving behavior, in particular relating to the dynamics of the present driving behavior, of the driver of the vehicle. The dynamics information may for example indicate the speed and/or frequency with which the driver of the vehicle demands drive torques and/or the level of the drive torques respectively demanded by the driver. The dynamics information may be ascertained for a certain period of time, for example a period of time of between 2 and 5 minutes, prior to the (demand) time at which the prediction of the start-up time is made. The start-up time can then be predicted in a particularly precise manner on the basis of the dynamics information.

In particular, the control unit may be configured to ascertain, for a sequence of future times (starting from the demand time), a respective first priority value for the electric machine being used for driving the vehicle and a second priority value for the electric machine being used for the starting operation of the internal combustion engine.

The first priority value at a particular time from the sequence of future times may in this case be ascertained for example: in a manner dependent on the driver demand relating to the drive torque demanded by the driver of the vehicle (in particular on the driver demand at the demand time); and/or in a manner dependent on dynamics information relating to the dynamics of the driving behavior of the driver of the vehicle (in particular on the dynamics information at the demand time).

The second priority value at a particular time from the sequence of future times may be ascertained for example: in a manner dependent on the duration that has elapsed since the (demand) time at which the demand for the internal combustion engine to be started was detected; and/or in a manner dependent on state of charge information relating to the state of charge of the electrical energy store for storing electrical energy for the operation of the electric machine (at the particular time); and/or in a manner dependent on an urgency of the demand for the starting of the internal combustion engine.

The start-up time can then be ascertained particularly precisely in a manner dependent on the first priority values and the second priority values in the sequence of future times. Here, the start-up time may be selected in particular as a time from the sequence of future times. For example, the time proceeding from which the second priority value is higher than the first priority value may be selected as start-up time.

According to a further aspect, a (road) motor vehicle (in particular a passenger motor vehicle or a heavy goods vehicle or a bus or a motorcycle) is described which comprises the control unit described in this document and/or the hybrid drive described in this document.

According to a further aspect, a computer-implemented method for operating a hybrid drive of a vehicle is described. The hybrid drive comprises an internal combustion engine and an electric machine, wherein the hybrid drive is configured such that the electric machine is used for providing a drive torque of the vehicle and for starting the internal combustion engine. The method comprises predicting a start-up time at which at least a proportion of the entire available total power of the electric machine is available for a starting operation of the internal combustion engine. The method furthermore comprises starting the internal combustion engine, by operation of the electric machine, at the predicted start-up time.

According to a further aspect, a software program is described. The software program may be configured to be executed on a processor, for example on a control unit of a vehicle, and to thus execute the method described in this document.

According to a further aspect, a memory medium is described. The memory medium may comprise a software program that is configured to be executed on a processor and to thus execute the method described in this document.

It is to be noted that the methods, devices and systems described in this document may be used both individually and in combination with other methods, devices and systems described in this document. Furthermore, any aspects of the methods, devices and systems described in this document may be combined with one another in a wide variety of ways. In particular, the features of the claims may be combined with one another in a wide variety of ways.

The invention will be described in more detail below on the basis of exemplary embodiments.

### BRIEF DESCRIPTION OF THE DRAWINGS

FIG. 1 shows an exemplary parallel hybrid drive with a separating clutch.

FIG. 2 shows a flow diagram of an exemplary method for operating the electric machine of a hybrid drive.

### DETAILED DESCRIPTION OF THE DRAWINGS

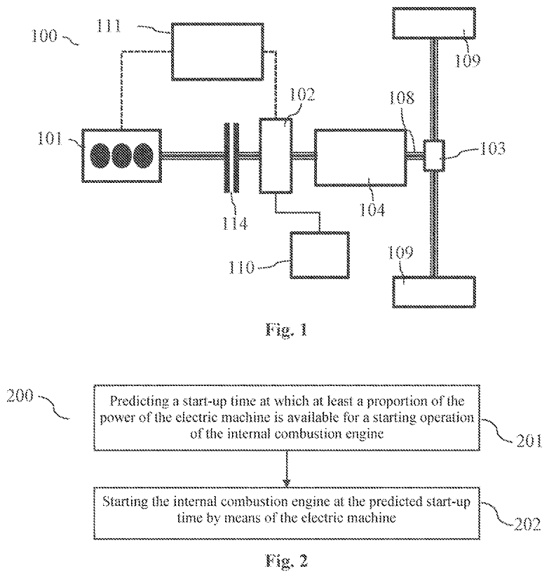

As discussed in the introduction, the present document is concerned with the operation of the electric machine of a hybrid drive. In this context, FIG. 1 shows a block diagram of an exemplary hybrid drive for a vehicle 100. A hybrid drive comprises an internal combustion engine 101 and an electric machine 102, which can be used individually or jointly to generate a drive torque for the vehicle 100. The internal combustion engine 101 and the electric machine 102 may be arranged such that the torques generated by the respective drive motor are added together to form a total drive torque, which is transmitted for example via a transmission 104, an output shaft 108 of the transmission 104 and an axle transmission 103 to one or more wheels 109 of the vehicle 100. The electrical energy for the operation of the electric machine 102 may be stored in an electrical energy store 110. Furthermore, the hybrid drive may comprise a separating clutch 114 that is configured to decouple the internal combustion engine 101 from the drivetrain (for example in order to stop the internal combustion engine 101). In the example illustrated in FIG. 1, the electric machine 102 is arranged between the separating clutch 114 and transmission 104. In an alternative example, the electric machine 102 may be arranged between the transmission 104 and the output shaft 108.

The vehicle 100 furthermore comprises a control unit 111 (for example an engine control unit) which is configured to determine a demanded total drive torque. The demanded total drive torque may be specified by a driver of the vehicle for example by way of an accelerator pedal and/or by way of a setting of the transmission 104. For example, a driver may actuate the accelerator pedal in order to demand an increased total drive torque. The control unit 111 may be configured to divide the demanded total drive torque into a first torque (for the internal combustion engine 101) and a second torque (for the electric machine 102). In other words, the control unit 111 may be configured to operate the internal combustion engine 101 and/or the electric machine 102 in a manner dependent on a demanded total drive torque (that is to say in a manner dependent on a driver demand).

In order to allow purely electrical operation, the internal combustion engine 101 can be stopped. The internal combustion engine 101 can then be started when required, for example because the state of charge of the electrical energy store 110 is low and/or at relatively high traveling speeds. The start-up of the internal combustion engine 101 may be performed by way of a dedicated starter (not illustrated). Alternatively, to reduce the structural space, the costs and the weight of the hybrid drive, the installation of a starter may be omitted, and the electric machine 102 may be used to carry out the starting operation of the internal combustion engine 101. This however has the effect that, during the starting operation, the electric machine 102 provides a certain starting power for the starting operation, which starting power is then no longer available for driving the vehicle 100. The starting power may for example correspond to approximately 20% of the available total power of the electric machine 102.

Therefore, during the operation of a starting operation, the drive power that can be provided by the electric machine 102 for driving the vehicle 100 is decreased. This can lead to an uncomfortable situation for the driver of the vehicle 100 if, for example in the event of an acceleration process, the starting operation of the internal combustion engine 101 results in a sudden decrease in the drive torque.

The control unit 111 may be configured to determine that the internal combustion engine 101 is to be started. This may be ascertained for example on the basis of an operating strategy for the hybrid drive. The operating strategy may for example comprise a characteristic map which indicates, in a manner dependent on the traveling speed of the vehicle 100 and/or in a manner dependent on the state of charge of the energy store 110, whether or not the internal combustion engine 101 is to be operated.

Furthermore, the control unit 111 may be configured to, in reaction to the demand for a starting operation of the internal combustion engine 101, predict a start-up time or a start-up time interval in which the power demand of the electric machine 102 corresponds at most to the total power minus the required starting power for the starting operation. The starting operation of the internal combustion engine 101 can then be shifted to the predicted start-up time or to the predicted start-up time interval. It can thus be reliably achieved that the operation of the vehicle 100 is not impaired by the start-up of the internal combustion engine 101.

A hybrid drive can thus be provided in the case of which no dedicated starting system is provided for the internal combustion engine 101 and in which a separate electric machine 102, in particular a traction electric machine, which is used primarily for propulsion, is additionally used for the starting of the internal combustion engine 101.

In this way, the start-up unit for the internal combustion engine 101 can be omitted, and costs, structural space, weight and complexity can thus be saved. On the other hand, during the start-up, the electric machine 102 is at least partially or entirely unavailable for the propulsion of the vehicle 100, whereby the driving behavior of the vehicle 100 can be impaired in some driving situations.

The above-stated problem may also arise in the case of a hybrid drive (as illustrated in FIG. 1) in which the internal combustion engine 101 can be started up by way of a clutch 114.

Here, the start-up of the internal combustion engine 101 may be effected by way of a so-called cranking start in the case of which the clutch 114 is closed such that the crankshaft of the internal combustion engine 101 is driven by the electric machine 102. In this case, it would be necessary for a power reserve to be kept available for the starting operation, which power reserve would then not be available for driving the vehicle 100.

The omission of a dedicated starting system and/or the use of a traction electric motor 102 for the starting operation is advantageous in particular in the case of a hybrid drive in which the internal combustion engine 101 is used not for providing a drive torque but merely as an energy converter. In the case of such a hybrid drive, the start-up of the internal combustion engine 101 can be delayed in a flexible manner, because the power of the internal combustion engine 101 is not required directly for propulsion.

This document describes a method that makes it possible to ascertain a suitable start-up time for the start-up of the internal combustion engine 101. Here, it is possible for the operating strategy of the hybrid drive and the driver demand, in particular the drive torque demanded by the driver, to be taken into consideration. A prioritization is possible which, in the presence of a start-up demand of the operating strategy, makes a decision on the basis of one or more criteria as regards what is more important at the respective time: the starting of the internal combustion engine 101 or the driving behavior of the vehicle 100. The start-up of the internal combustion engine 101 can consequently be performed at a start-up time (possibly delayed in relation to the demand time) at which the start-up of the internal combustion engine 101 has no relevance for the driving behavior. For this purpose, the start-up demand of the operating strategy may be delayed or suppressed as long as the electric motor 102 is more important for propulsion than for the start-up of the internal combustion engine 101.

Two priority values may be calculated and compared with one another. In particular, a first priority value Prio_propulsion may be ascertained for the electric motor 102 being used for propulsion. Furthermore, a second priority value Prio_start-up may be ascertained for the electric machine 102 being used for the start-up of the internal combustion engine 101. The start-up demand of the operating strategy may be suppressed as long as the following applies: Prio_propulsion>Prio_start-up.

The priority value Prio_propulsion for propulsion may be ascertained for example using the sum

Prio_propulsion=P_V_present_driver_demand+P_V_driver_dynamics

where P_V_present_driver_demand is a value that is dependent on the present driver demand. If, at a particular time, for an acceleration process, the driver demands for example more propulsion than the remaining one or more torque sources can provide, the influence of the driver demand on the first priority value Prio_propulsion is relatively great. On the other hand, it is to be assumed that the acceleration process will have been ended at a particular point in time, such that the demanded drive torque will fall and such that, at this future time, a start-up can be performed without any influence on the driving behavior.

If, in a further example, the driver of the vehicle 100 activates a brake pedal, then the likelihood that the driver will demand a maximum possible drive torque for acceleration in the immediate future is relatively low. Furthermore, owing to damping of abrupt load alterations, the duration until the maximum possible drive torque is provided is typically sufficient to carry out the start-up of the internal combustion engine 101 before the drive torque is provided.

The abovementioned priority value P_V_driver_dynamics is a weighted integrator of the driving dynamics of the vehicle 100 over a past period of time, for example a period of time of 5 minutes. In other words, the priority value P_V_driver_dynamics indicates the present driving behavior of the driver of the vehicle 100 relating to the dynamics of the driving style. In the case of relatively dynamic driving behavior, there is increased likelihood that a relatively high drive torque will be demanded at short notice even if a relatively low drive torque is presently demanded. In such a situation, it may thus be advantageous to delay the start-up of the internal combustion engine 101 in order to await a start-up time at which the driving dynamics have decreased.

The second priority value Prio_start-up for the start-up may be ascertained for example on the basis of the following sum:

Prio_start-up=P_Z_timer+P_Z_soc+P_Z_emergency_running

where the priority value P_Z_timer is a counter that is initialized (in particular set to 0) at the demand time of the start-up demand of the operating strategy and is then increased over time in order to indicate the increasing urgency of the start-up of the internal combustion engine 101. It can thus be ensured that the start-up of the internal combustion engine 101 is not delayed for an unlimited length of time. The start-up may thus take place at a point in time at which the propulsion of the vehicle 100 is impaired if no suitable time for the start-up arises over a relatively long period of time.

The priority value P_Z_soc is dependent on the state of charge of the energy store 110 and typically increases with decreasing state of charge (SOC) of the energy store 110. It can thus be ensured that the state of charge does not decrease to too great an extent as a result of the delay of the start-up. Furthermore, by way of the priority value P_Z_emergency_running, it can be achieved that, if an emergency running manager demands the immediate start-up of the internal combustion engine 101, for example because the energy store 110 is suddenly no longer providing power, the immediate start-up of the internal combustion engine 101 is performed.

FIG. 2 shows a flow diagram of an exemplary method 200 for operating a hybrid drive of a vehicle 100. Here, the hybrid drive comprises an internal combustion engine 101 and an electric machine 102, wherein the hybrid drive is configured such that the electric machine 102 is used for providing a drive torque of the vehicle 100 (that is to say for driving the vehicle 100) and for starting the internal combustion engine 101. In particular, the hybrid drive may be configured such that no dedicated starter is provided for starting the internal combustion engine 101, but rather the electric machine 102 must be used for starting the internal combustion engine 101. The method 200 may also be executed by a control unit 111 of the hybrid drive or of the vehicle 100.

The method 200 comprises predicting 201 a start-up time at which at least a proportion of the total power of the electric machine 102 is available for a starting operation of the internal combustion engine 101 and is not used for driving the vehicle 100. Here, the start-up time may be predicted in a manner dependent on the driving behavior of the driver of the vehicle 100 and/or in a manner dependent on the present driver demand relating to the drive torque.

Furthermore, the method 200 comprises starting 202 the internal combustion engine 101 at the predicted start-up time by way of the electric machine 102. The start-up of the internal combustion engine 101 is thus not necessarily performed directly at the demand time at which the start-up demand is initiated, for example by the operating strategy of the hybrid drive. Rather, the start-up can be shifted to a suitable start-up time, in particular in order to reduce, or entirely eliminate, the effects of the start-up on the drive and/or on the driving behavior of the vehicle 100.

By way of the measures described in this document, comfortable and reliable operation of a hybrid drive can be made possible even in the case of an electric machine 102 being used jointly for providing drive and for starting up the internal combustion engine 101.

The present invention is not restricted to the exemplary embodiments shown. In particular, it is to be noted that the description and the figures are intended merely to illustrate the principle of the proposed methods, devices and systems.

1-10. (canceled)

11. A control unit for a hybrid drive of a vehicle, wherein the hybrid drive comprises an internal combustion engine and an electric machine, wherein the hybrid drive is configured such that the electric machine is used for providing a drive torque of the vehicle and for starting the internal combustion engine, and wherein the control unit is configured:
to predict a start-up time at which at least a proportion of a total power of the electric machine is available for a starting operation of the internal combustion engine; and
to start the internal combustion engine by way of the electric machine at the predicted start-up time.

12. The control unit according to claim 11, wherein the control unit is further configured:
to determine, based on an operating strategy of the hybrid drive, that the internal combustion engine is to be started; and,
in reaction thereto, to predict the start-up time at which at least the proportion of the total power of the electric machine is available for the starting operation of the internal combustion engine.

13. The control unit according to claim 12, wherein the control unit is further configured:
to ascertain speed information relating to a traveling speed of the vehicle; and/or
to ascertain state of charge information relating to a state of charge of an electrical energy store for storing electrical energy for operation of the electric machine; and,
in a manner dependent on the speed information and/or the state of charge information and taking into consideration the operating strategy, to determine that the internal combustion engine is to be started.

14. The control unit according to claim 11, wherein the control unit is further configured:
to ascertain a driver demand relating to a drive torque demanded by a driver of the vehicle; and
to predict the start-up time based on the driver demand.

15. The control unit according to claim 11, wherein the control unit is further configured:
to ascertain dynamics information relating to dynamics of a driving behavior of a driver of the vehicle; and
to predict the start-up time based on the dynamics information.

16. The control unit according to claim 15, wherein the driving behavior is a present driving behavior of the driver of the vehicle.

17. The control unit according to claim 11, wherein the control unit is further configured:
to ascertain, for a sequence of future times, a respective first priority value for the electric machine being used for driving the vehicle and a respective second priority value for the electric machine being used for the starting operation of the internal combustion engine; and
to ascertain the start-up time in a manner dependent on the first priority values and the second priority values in the sequence of future times.

18. The control unit according to claim 17, wherein the control unit is further configured to select the start-up time as a time from the sequence of future times.

19. The control unit according to claim 17, wherein the control unit is further configured to ascertain the first priority value at a time from the sequence of future times:
in a manner dependent on a driver demand relating to a drive torque demanded by a driver of the vehicle; and/or
in a manner dependent on dynamics information relating to dynamics of a driving behavior of the driver of the vehicle.

20. The control unit according to claim 17, wherein the control unit is further configured to ascertain the second priority value at a time from the sequence of future times:
in a manner dependent on a duration that has elapsed since a time at which a demand for the internal combustion engine to be started was detected; and/or
in a manner dependent on state of charge information relating to a state of charge of an electrical energy store for storing electrical energy for operation of the electric machine; and/or
in a manner dependent on an urgency of the demand for the internal combustion engine to be starting.

21. The control unit according to claim 11, wherein:
the hybrid drive is configured such that the electric machine is usable in a chronologically exclusive manner only for providing drive or only for the starting operation of the internal combustion engine; and
the control unit is further configured to predict a start-up time at which the electric machine is not required for driving the vehicle; or
the hybrid drive is further configured such that the electric machine can, out of the entire available total power, use a starting power for the starting operation of the internal combustion engine and a remainder of the total power for driving the vehicle; and
the control unit is further configured to predict a start-up time at which at most the total power minus the starting power is required for driving the vehicle.

22. A method for operation of a hybrid drive of a vehicle, wherein the hybrid drive comprises an internal combustion engine and an electric machine, and wherein the hybrid drive is configured such that the electric machine is used for providing a drive torque of the vehicle and for starting the internal combustion engine, the method comprising:
predicting a start-up time at which at least a proportion of a total power of the electric machine is available for a starting operation of the internal combustion engine; and
starting the internal combustion engine by way of the electric machine at the predicted start-up time.
